(19) United States
(12) Patent Application Publication
(10) Pub. No.: US 2022/0152899 A1
(43) Pub. Date: May 19, 2022

(54) SHOOTING POT TEMPERATURE REGULATION

(71) Applicant: HUSKY INJECTION MOLDING SYSTEMS LTD., BOLTON (CA)

(72) Inventor: Manon Danielle BELZILE, Fairfield, VT (US)

(21) Appl. No.: 17/593,412

(22) PCT Filed: Mar. 3, 2020
(86) PCT No.: PCT/CA2020/050282

§ 371 Date: Sep. 17, 2021

Related U.S. Application Data
(60) Provisional application No. 62/828,054, filed on Apr. 2, 2019.

(51) Int. Cl. B29C 45/74; B29C 45/53; B29C 45/78

(52) U.S. Cl. CPC B29C 45/74; B29C 45/535; B29C 45/78; B29C 2945/76678; B29C 2945/762; B29C 2945/76531; B29C 2945/7604

(57) ABSTRACT

Disclosed is a system and a related method for regulating a temperature in a shooting pot associated with an injection molding machine. The structure includes, amongst other things, a cooling circuit and thermocouple proximate a plunger entry end of the shooting pot as well as a cooling adjustment unit for controlling an amount of cooling provided by the cooling fluid. In operation a controller coupled with the cooling adjustment unit and the thermocouple controls the cooling adjustment unit based on a temperature reading associated with the thermocouple.

### TECHNICAL FIELD

The present disclosure relates to injection molding and, in particular, to methods and systems that regulate a temperature of resin in a plunger entry end of a shooting pot to reduce leakage of the resin.

### BACKGROUND

Injection molding machines sometimes include a shooting pot which is used to meter material of a plastic resin so that cavities in a multi-cavity mold receive an appropriate amount of the resin during a molding cycle. A shooting pot housing, which may also be referred to as a shooting pot cylinder, may define a cylindrical cavity through which a plunger or piston may move to expel resin from the shooting pot cylinder. That is, the plunger or piston may be actuated to discharge the resin into a hot runner manifold, which carries the resin to an injection nozzle and then into the mold cavity.

The resin, which is in solid form at room temperature, may be heated to maintain the resin in a liquid form to allow for injection into the mold cavity. However, heating the resin to a high temperature can also cause leakage. More specifically, such heating can cause the resin to leak from undesirable locations of the shooting pot, such as a plunger entry end of the shooting pot. The plunger entry end of the shooting pot is the portion of the shooting pot cylinder that is furthest from the outlet end of the shooting pot. The outlet end of the shooting pot cylinder is the portion of the shooting pot cylinder through which resin is expelled when the plunger is actuated. The plunger entry end of the shooting pot is, therefore, the end of the shooting pot cylinder which opposes the outlet end of the shooting pot cylinder. Resin can leak from the plunger entry end of the cylinder due to the clearance between the plunger and the shooting pot cylinder.

Resin leakage can be problematic for a number of reasons. For example, resin leakage may decrease the accuracy of the size of the shot being injected. Further, leakage results in wasted resin and can also cause a build-up of material in undesirable parts of the injection molding machine which eventually requires cleanup.

Thus, improved methods and systems for reducing leakage of resin from a shooting pot are desirable.

### BRIEF DESCRIPTION OF DRAWINGS

Reference will now be made, by way of example, to the accompanying drawings which show example embodiments of the present application and in which:

FIG. 1 shows an exploded perspective view of an example auxiliary injection assembly in accordance with an example embodiment of the present disclosure.

FIG. 2 shows a cross section of a portion of the example auxiliary injection assembly.

FIG. 3 shows a block diagram of example components of a system of regulating temperature of a shooting pot.

FIG. 4 is a flowchart of an example method of regulating temperature of a shooting pot.

Like reference numerals are used in the drawings to denote like elements and features.

### DETAILED DESCRIPTION OF EXAMPLE EMBODIMENTS

In a first aspect, the present disclosure describes a system for regulating a temperature in a shooting pot associated with an injection molding machine. The system comprising a cooling circuit proximate a plunger entry end of the shooting pot, the cooling circuit configured to allow a cooling fluid to pass therethrough; a thermocouple proximate the plunger entry end of the shooting pot; a cooling adjustment unit for controlling an amount of cooling provided by the cooling fluid; and a controller coupled with the cooling adjustment unit and the thermocouple for controlling the cooling adjustment unit based on a temperature reading associated with the thermocouple.

In another aspect, the present disclosure describes a method of regulating a temperature in a shooting pot associated with an injection molding machine. The method comprising receiving a temperature reading associated with a thermocouple proximate a plunger entry end of a shooting pot; and controlling a cooling adjustment unit based on the temperature reading, the cooling adjustment unit controlling an amount of cooling provided by a cooling fluid in a cooling circuit proximate a plunger entry end of the shooting pot.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

As will be described in greater detail below, temperature at a plunger entry end of a shooting pot may be regulated to maintain resin at a target temperature. The target temperature may be a temperature range in which the resin has a desired viscosity or a specific temperature within the range. Accordingly, the range of temperature is defined on the resin type and application. At the target temperature, the resin is thick enough in consistency to prevent leakage of the resin from the plunger entry end of the shooting pot. The resin is also thin enough in consistency to prevent the resin from affecting operation of the shooting pot (e.g., by seizing the plunger). The temperature is maintained at the desired consistency through the use of a cooling circuit which is configured to allow a cooling fluid to pass therethrough. A cooling adjustment unit, such as a flow control valve, e.g. solenoid valve or proportional flow control valve, is used to control the amount of cooling that is provided by the cooling fluid and the cooling adjustment unit is controlled based on a temperature reading associated with a thermocouple that is positioned proximate the plunger entry end of the shooting pot.

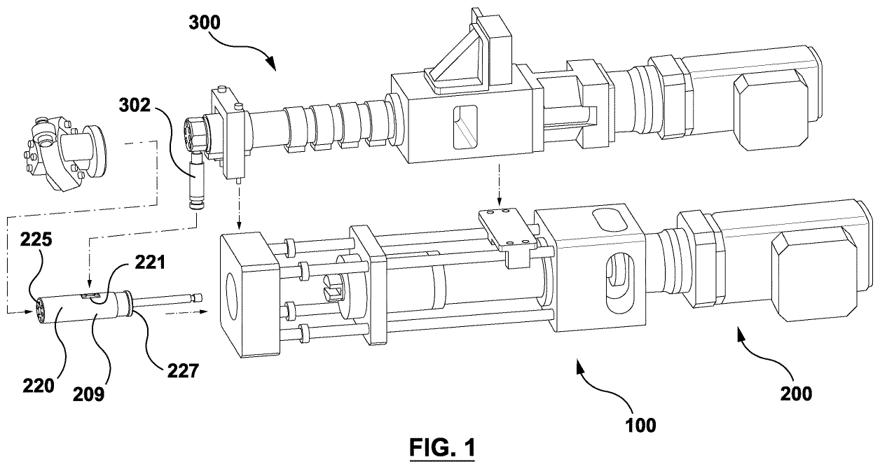

An overview having been provided, reference will now be made to FIG. 1 which illustrates an example injection assembly 100. In the illustrated example, the injection assembly 100 is an auxiliary injection assembly. The auxiliary injection assembly 100 is an auxiliary unit which may be added to a main injection molding machine to expand the capabilities or features of the main injection molding machine. That is, the auxiliary injection assembly is configured to be removably connected to an injection molding machine. However, the techniques, methods and systems described herein may also be applied to features of a main injection molding machine. For example, a primary shooting pot of an injection molding machine may use the temperature regulation features described herein.

In the example illustrated, the injection assembly 100 includes a first injection module 200 and a second injection module 300. The first injection module 200 is a shooting pot unit and the second injection module 300 is a plasticizing unit. The plasticizing unit melts polymer material and the shooting pot unit injects the melted polymer material (which may be referred to as a resin) into a cavity of a mold.

To melt the polymer material, the plasticizing unit includes a plasticizing screw which rotates to melt the polymer material and to advance the polymer unit through the plasticizing unit. For example, solid polymer material may be loaded into a hopper which feeds a barrel in which the plasticizing screw is located. The plasticizing screw rotates and the polymer material is melted and moved forward in the barrel of the plasticizing unit. The melted polymer material (i.e., the resin) may then pass through a transfer tube 302. The transfer tube transfers the resin into a shooting pot of the first injection module 200 (i.e., of the shooting pot unit).

The transfer tube 302 provides a fluid connection between a barrel head (i.e. the end of the barrel in which the plasticizing screw is located) and a shooting pot 209. The shooting pot 209 includes a plunger 210 and a shooting pot housing 220 (which may also be referred to as a shooting pot cylinder), which defines a cavity for receiving the plunger 210. The transfer tube 302 transfers the resin into the cavity defined by a shooting pot housing 220. The transfer tube 302 connects to the shooting pot housing 220 at a first point (opening 221) between a first end 225 and an opposite second end 227 of the shooting pot housing. The first end 225 of the shooting pot housing is an outlet end of the shooting pot housing. The outlet end is the end through which a shot of resin is expelled. The second end 227 opposes the first end 225. The second end 227 may also be referred to as a rear end or plunger entry end of the shooting pot. The plunger entry end is the end that receives the plunger 210. The plunger entry end is also the end of the shooting pot 209 which is nearest an actuator which imparts linear motion to the plunger 210.

The plunger 210 is movable linearly with respect to the body of the first injection module 200 and the shooting pot housing 220 disposed at a first end of the plunger 210. The actuator in the first injection module 200 may be used to impart linear motion to the plunger 210. For example, in at least some embodiments, the first injection module 200 may include a ball screw connected to the plunger 210 and a rotational power source coupled to the ball screw to impart a rotational force to the ball screw. When a rotational force is applied, the ball screw may cause linear motion of a fixed nut coupled to the plunger 210, thereby driving the plunger 210 linearly forward or linearly retracting it, according to the rotation of the ball screw.

The plunger 210 is positioned in the first injection module 200 such that the leading end of the plunger 210 is movable between opposite sides of the opening 221 along the shooting pot housing 220. That is, the plunger 210 can be driven forward linearly in the shooting pot housing 220 to push a shot of the melt flowing through the opening 221 and retracted linearly until the next shot of melt is ready to be advanced in the shooting pot housing 220.

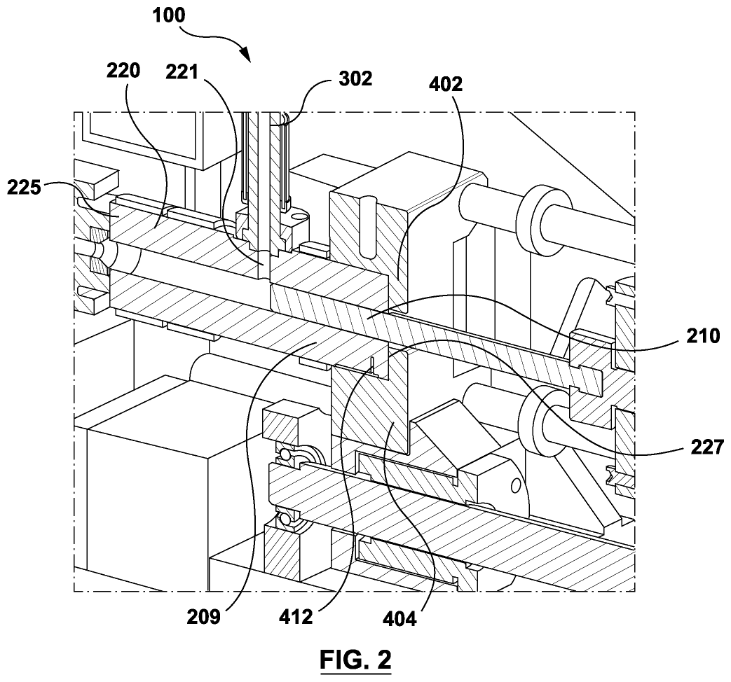

Referring now to FIG. 2, a cross sectional view of a portion of the injection assembly 100 is illustrated. As illustrated in FIG. 2, the plunger 210 travels within a cavity defined by the shooting pot housing 220. Resin flows through the opening 221 into the cavity. The consistency of the resin in the cavity could cause at least some resin to travel through any space between the plunger and the shooting pot housing 220 and to drip from the rear end (i.e., the second end 227) of the shooting pot 209. To reduce the possibility of such leakage, the injection assembly 100 may be equipped with a system for regulating temperature in the shooting pot. This system may include a cooling circuit 402 configured to allow a cooling fluid to pass therethrough. The cooling circuit is positioned proximate the plunger entry end (i.e., the second end 227) of the shooting pot 209. In the example illustrated, at least a portion of the cooling circuit is defined by a front drive housing 404 of the injection assembly. The front drive housing 404 is portion of the injection assembly 100 which supports the shooting pot 209. In the example illustrated, the front drive housing 404 supports the rear end of the shooting pot and defines a channel which acts as a portion of the cooling circuit 402. The cooling circuit 402 allows a cooling fluid, such as water, to flow within the cooling circuit. In the example, at least a portion of the cooling circuit is located within three (3) centimeters of the shooting pot. The closer the cooling circuit is to the rear end of the shooting pot, the more effective the cooling properties of the cooling circuit for cooling the rear end of the shooting pot. The cooling circuit 402 may include other portions that are not specifically illustrated in FIG. 2. These portions may generally be provided by piping or channels through which the cooling fluid can flow.

The system for regulating temperature also includes a thermocouple 412 proximate the plunger entry end (i.e., the rear end or second end 227) of the shooting pot 209. In the illustrated example, the thermocouple is located within a slot defined in the shooting pot housing 220. The thermocouple is, in the example, located within three (3) centimeters of the second end 227 of the shooting pot. The thermocouple is a temperature sensor which produces a temperature reading based on a sensed temperature. For example, the temperature reading may be a temperature-dependent voltage which is generated as a result of thermoelectric effect and this voltage can be used by a controller as a temperature reading or temperature measurement.

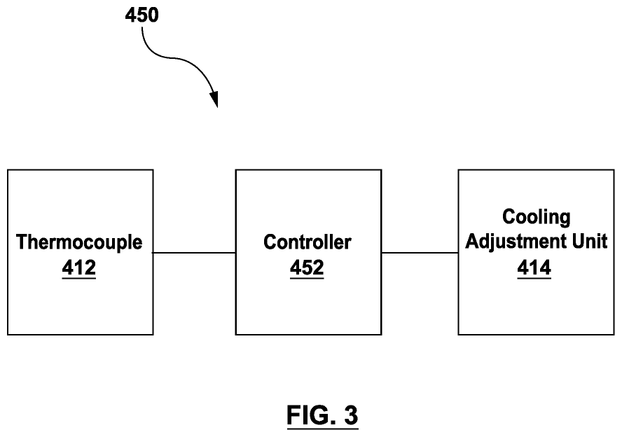

The system for regulating temperature includes other components not illustrated in FIG. 2. For example, referring now to FIG. 3, a block diagram of electrical components of the system 450 for regulating temperature is illustrated. The system 450 includes the thermocouple 412 which is coupled with a controller 425. The controller 425 may be, for example, a processor. The controller 425 is coupled with a cooling adjustment unit 414 which controls an amount of cooling provided by the cooling fluid in the cooling circuit 402. The controller 452 may be configured to control the cooling adjustment unit based on a temperature reading associated with the thermocouple.

In at least some embodiments, the cooling adjustment unit 414 is a flow control valve, e.g. solenoid valve or a proportional flow control valve, coupled to the cooling circuit 402. The flow control valve regulates the flow of the cooling fluid within the cooling circuit.

The controller 452 may be configured to control the flow control valve to maintain a target temperature. As explained previously, the target temperature may be a range of temperature or a specific temperature within the range. A technical effect of controlling using a target temperature that is a range of temperature is that the flow is not triggered on and off too rapidly which may reduce the life of the switching components i.e. solenoid valve. For example, after determining that a greater amount of cooling is required (i.e., that the temperature reading from the thermocouple is greater than the target temperature), the flow control valve may be actuated by the controller 252 to increase flow of the cooling fluid. Similarly, after determining that a lesser amount of cooling is required (i.e., that the temperature reading from the thermocouple is less than the target temperature), the flow control valve may be actuated by the controller 252 to decrease flow of the cooling fluid. The target temperature is selected to maintain a consistency of resin near the plunger entry end of the shooting pot to reduce leakage of the resin from the plunger entry end of the shooting pot and the target temperature may be defined in memory associated with the controllers.

Other cooling adjustments may also be used to regulate the temperature in the shooting pot. For example, in some instances, the cooling adjustment unit may be a heater or cooling unit. The controller 252 may control a heater or cooling unit based on temperature readings from the thermocouple. For example, the controller 252 may control the heater to increase the amount of heat after determining that the temperature reading is less than the target temperature. Similarly, the controller 252 may control the heater to decrease the amount of heat after determining than the temperature reading is greater than a target temperature. The heater or cooling unit may be situated to either adjust the temperature of the cooling fluid or to adjust the temperature of the resin in the shooting pot directly.

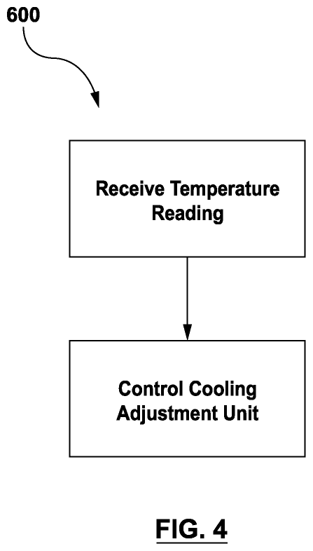

Referring now to FIG. 4, a flowchart of an example method 600 is illustrated. The example method 600 may be performed, for example, by a controller 252. For example, the controller 252 may be a processor and a memory associated with the processor may store processor-executable instructions which, when executed, configure the processor to perform the method 600.

At operation 602, the controller 452 receives a temperature reading associated with a thermocouple 412. As described above, the thermocouple 412 may be positioned proximate a plunger entry end of a shooting pot.

At operation 604, the controller 452 controls a cooling adjustment unit based on the temperature reading. As described above, the cooling adjustment unit may control an amount of cooling provided by a cooling fluid (such as water) in a cooling circuit that is proximate a plunger entry end of the shooting pot.

As noted in the discussion of FIG. 3 above, the cooling adjustment unit may be a flow control valve connected to the cooling circuit for regulating the flow of the cooling fluid within the cooling circuit. In such embodiments, at operation 604, the controller 452 may control the cooling adjustment unit by controlling the flow control valve to maintain a target temperature. In some embodiments, at operation 604, the controller 452 controls the cooling adjustment unit by increasing flow of cooling fluid after determining that the temperature reading is greater than the target temperature. The target temperature may be selected to maintain a consistency of resin near the plunger entry end of the shooting pot to reduce leakage of the resin from the plunger entry end of the shooting pot.

In some embodiments, at operation 604, the controller 452 controls the cooling adjustment unit by decreasing flow of cooling fluid after determining than the temperature reading is less than the target temperature.

In some embodiments, the cooling adjustment unit may be a heater or a cooling unit. In some such cases, at operation 604, the controller 452 controls the cooling adjustment unit by controlling the heater to increase the amount of heat after determining than the temperature reading is less than a target temperature. In other instances, at operation 604, controls the cooling adjustment unit by controlling the heater to decrease the amount of heat after determining than the temperature reading is greater than a target temperature.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A system for regulating a temperature in a shooting pot associated with an injection molding machine, the system comprising:
a cooling circuit proximate a plunger entry end of the shooting pot, the cooling circuit configured to allow a cooling fluid to pass therethrough;
a thermocouple proximate the plunger entry end of the shooting pot;
a cooling adjustment unit for controlling an amount of cooling provided by the cooling fluid; and
a controller coupled with the cooling adjustment unit and the thermocouple for controlling the cooling adjustment unit based on a temperature reading associated with the thermocouple.

2. The system of claim 1, wherein the cooling adjustment unit is a flow control valve connected to the cooling circuit for regulating the flow of the cooling fluid within the cooling circuit.

3. The system of claim 2, wherein the controller is configured to control the flow control valve to maintain a target temperature.

4. The system of claim 3, wherein the controller is configured to increase flow of cooling fluid after determining that the temperature reading is greater than the target temperature.

5. The system of claim 3, wherein the controller is configured to decrease flow of cooling fluid after determining than the temperature reading is less than the target temperature.

6. The system of claim 3, wherein the target temperature is selected to maintain a consistency of resin near the plunger entry end of the shooting pot to reduce leakage of the resin from the plunger entry end of the shooting pot.

7. The system of claim 2, wherein the cooling fluid is water.

8. The system of claim 1 or 2, wherein the cooling adjustment unit is a heater.

9. The system of claim 8, wherein the controller is configured to control the heater to increase an amount of heat after determining than the temperature reading is less than a target temperature.

10. The system of claim 9, wherein the controller is configured to control the heater to decrease an amount of heat after determining than the temperature reading is greater than a target temperature.

11. The system of claim 1, wherein the shooting pot is provided on an auxiliary injection assembly associated with the injection molding machine, the auxiliary injection assembly configured to be removably connected to the injection molding machine.

12. A method of regulating a temperature in a shooting pot associated with an injection molding machine, the method comprising:
receiving a temperature reading associated with a thermocouple proximate a plunger entry end of a shooting pot; and
controlling a cooling adjustment unit based on the temperature reading, the cooling adjustment unit controlling an amount of cooling provided by a cooling fluid in a cooling circuit proximate a plunger entry end of the shooting pot.

13. The method of claim 12, wherein the cooling adjustment unit is a flow control valve connected to the cooling circuit for regulating the flow of the cooling fluid within the cooling circuit, and wherein controlling the cooling adjustment unit comprises controlling the flow control valve to maintain a target temperature.

14. The method of claim 13, wherein controlling the cooling adjustment unit comprises increasing flow of cooling fluid after determining that the temperature reading is greater than the target temperature.

15. The method of claim 13, wherein controlling the cooling adjustment unit comprises decreasing flow of cooling fluid after determining than the temperature reading is less than the target temperature.

16. The method of claim 13, wherein the target temperature is selected to maintain a consistency of resin near the plunger entry end of the shooting pot to reduce leakage of the resin from the plunger entry end of the shooting pot.

17. The method of claim 13, wherein the cooling fluid is water.

18. The method of claim 12 or 13, wherein the cooling adjustment unit is a heater.

19. The method of claim 18, wherein controlling the cooling adjustment unit comprises controlling the heater to increase the amount of heat after determining than the temperature reading is less than a target temperature.

20. The method of claim 19, wherein controlling the cooling adjustment unit comprises controlling the heater to decrease the amount of heat after determining than the temperature reading is greater than a target temperature.

21. The method of claim 13, wherein the target temperature is a range of temperature in which a resin in the shooting pot has a desired viscosity or a specific temperature within the range.
